(19) United States
(12) Patent Application Publication
(10) Pub. No.: US 2016/0186884 A1
(43) Pub. Date: Jun. 30, 2016

(54) ACTUATING DEVICE AND METHOD FOR ACTUATING A VALVE

(71) Applicant: CCI AG, Balterswil (CH)

(72) Inventor: Michael HARTMANN, Gailingen (DE)

(73) Assignee: CCI AG, Balterswil (CH)

(21) Appl. No.: 14/909,475

(22) PCT Filed: Aug. 6, 2014
(86) PCT No.: PCT/EP2014/066910

§ 371 Date: Feb. 2, 2016

(30) Foreign Application Priority Data
Aug. 16, 2013 (EP) 13180734.9

(51) Int. Cl. F16K 31/122; G21C 15/24; G21C 7/32

(52) U.S. Cl. CPC F16K 31/1221; G21C 7/32; G21C 15/24

(57) ABSTRACT

An actuation apparatus includes a housing and a piston. The housing has an inlet for a pneumatic or hydraulic actuation medium to pass into at least one piston space of the housing. The piston is movably arranged in the piston space. The piston can be moved by the actuation medium at least between an open position and a closed position, such that a valve can be actuated at least by movement from the open position into the closed position. In the closed position, the piston and the housing are in operative connection with one another such that a seal is formed downstream of the inlet for sealing the piston space for the actuation medium. At least the regions of the piston and of the housing in operative connection have a modulus of elasticity greater than 10 kN/mm2.

### CROSS-REFERENCE TO RELATED APPLICATIONS

This application is a U.S. National Stage Application of International Application No. PCT/EP2014/066910, filed Aug. 6, 2014, which claims priority to European Application No. 13180734.9, filed Aug. 16, 2013, the contents of each of which is hereby incorporation herein by reference.

### BACKGROUND

1. Field of Invention

The invention relates to an actuation apparatus, to a method of actuating a valve and to a power plant comprising the actuation apparatus in accordance with the preamble of the independent claims.

2. Background Information

Pneumatic or hydraulic actuation apparatus are known from the prior art with which a valve of a cooling system or an energy generation system of a power plant can be actuated. Such an actuation apparatus can be arranged, for example, in an emergency cooling system or in a safety system for the prevention of excess pressure in an energy generation system of a nuclear power plant.

This already known prior art, however, has the disadvantage that a service life of the actuation apparatus is reduced too greatly by the temperatures occurring in the power plant and possibly by radioactive radiation. In addition, during the operation of the actuation apparatus, there is often a consumption of the pneumatic or hydraulic actuation medium such as air or water. A further disadvantage is possible damage to the valve by the actuation apparatus when the pressure exerted on the valve by the pneumatic or hydraulic actuation medium by means of the actuation apparatus rises too much, for example due to an incident.

### SUMMARY

It is therefore an object of the present invention to avoid the disadvantages of what is known, in particular to provide an actuation apparatus and a method with which the service life can be extended, which have a smaller consumption of pneumatic or hydraulic actuation medium and which are more reliable in operation with respect to pressure fluctuations in the pneumatic or hydraulic actuation medium.

These objects are satisfied by an actuation apparatus, by a power plant comprising the actuation apparatus described herein.

The actuation apparatus in accordance with the invention comprises a housing having an inlet for a pneumatic or hydraulic actuation medium in at least one piston space of the housing. A piston is movably arranged in the piston space. The piston can be moved by the actuation medium at least between an open position and a closed position such that a valve can be actuated at least by a movement from the open position into the closed position. In the closed position, the piston and the housing are in operative connection with one another such that a seal is formed downstream of the inlet for sealing the piston space for the actuation medium. The seal in particular comprises a sealing surface of the housing. The sealing in particular takes place with respect to the environment of the actuation apparatus. At least the regions of the piston and of the housing in operative connection have a modulus of elasticity E greater than 10 kN/mm². The modulus of elasticity E is preferably greater than 50 kN/mm² and particularly preferably greater than 100 kN/mm².

In this application, an arrangement of the piston in the piston space is understood such that at least a part of the piston is arranged in the piston space and optionally the total piston. It is naturally possible that a part of the piston is arranged in the piston space and a further part of the piston projects out of the housing so that the valve can be actuated. It is alternatively also conceivable that the piston can actuate the valve via an operative connection with a plunger.

The forming of the seal downstream in particular takes place such that the actuation medium can be conveyed further into the piston space through the inlet and the actuation medium can substantially not be conveyed downstream of the seal.

In this application, a pneumatic or hydraulic actuation medium is understood as gases or liquids which can be conveyed at pressure into the piston space for actuating the piston. For example, air, steam, further gases or any desired combinations thereof can be used as the pneumatic actuation medium. Furthermore, water, other liquids or any desired combinations thereof can be used as the hydraulic actuation medium, for example. A pneumatic actuation medium is preferably used.

The configuration of the regions of the piston and of the housing in operative connection in the closed position has the advantage that the service life of materials suitable for sealing having a modulus of elasticity E greater than 10 kN/mm² is significantly extended with respect to seals comprising soft materials such as elastomers under the environmental conditions present in power plants and in particular in nuclear power plants.

It is naturally conceivable that the housing and the piston have the same modulus of elasticity E at least in the regions in operative connection in the closed position. Alternatively, it is also conceivable that the regions in operative connection in the closed position have a different modulus of elasticity E.

The housing preferably has at least one plunger guide having a plunger arranged movably therein. The plunger is movable by the piston at least from a start position into an end position for actuating the valve. The plunger guide is in particular arranged downstream of the piston space with respect to the conveying direction of the actuation medium.

This has the advantage that the piston can be decoupled from the plunger so that a direct action on the valve by a possibly greatly fluctuating pressure in the actuation medium is avoidable so that damage to the valve can be avoided for a higher service life and a more reliable operation.

In this application, an arrangement of the plunger in the plunger guide is understood such that at least a part of the plunger is arranged in the plunger guide, and optionally the total plunger. It is naturally conceivable that a part of the plunger projects into the piston space and/or projects out of the plunger guide such that the valve can be actuated. A plunger guide can be configured, for example, as a recess and/or path in the housing.

A spring element is preferably arranged between the piston and the plunger with respect to an effective direction of the force of the piston on the plunger for damping and/or decoupling the force exerted by the actuation medium onto the piston from the plunger. The spring element is in particular a compression spring.

The arrangement of the spring element between the piston and the plunger has the advantage that pressure fluctuations, and in particular pressure peaks, in the operation of the valve can be reliably damped or can optionally be substantially completely decoupled.

The plunger guide and/or a recess in the closed position of the piston is/are preferably substantially sealed with respect to the piston space by means of the seal. The recess is arranged on the side remote from the piston space. The plunger guide and/or the recess is/are in particular in flow communication with the environment of the actuation apparatus. This has the advantage that the actuation medium can be conveyed out of the actuation apparatus, as required, through the flow connection.

A resetting device in operative connection with the piston and/or optionally with the plunger is preferably arranged at or in the housing for resetting the piston to the open position and/or optionally for resetting the plunger into the start position. The resetting device is in particular configured as a resetting spring.

This has the advantage that, after ending the conveyance of the actuation medium into the housing, a resetting of the actuation apparatus can take place so that the actuation apparatus can be used again, for example, for a repeat actuation of the valve. The use of a resetting spring as a resetting device has the advantage that the resetting can take place reliably without further drive means.

The resetting device can, for example, alternatively be configured as an electric motor. A pneumatically and/or hydraulically operable resetting device is naturally also conceivable in which, for example, the pneumatic or hydraulic actuation medium can be used.

An abutment for the piston is preferably arranged at and/or in the housing, with at least a region of the piston being in operative connection with the abutment in the closed position. This has the advantage that a position of the piston can be reliably defined for restricting the force exerted onto the valve independently of the pressure of the actuation medium. A maximum force exerted onto the valve can thus be set, in particular on the arrangement of a spring element between the piston and the plunger, in dependence on the position of the abutment and of the spring element used due to the compression of the spring element.

At least one sealing section of the sealing surface is preferably inclined at an angle w larger than 0° and smaller than 90° with respect to the direction of movement of the piston at intended use, with the piston being configured, and in particular chamfered, in the sealing region of the operative connection such that the operative connection of the piston with the housing takes place for forming the seal. The sealing section is preferably inclined at an angle w larger than 15° and smaller than 75°, and especially preferably larger than 30° and smaller than 60° at intended use. The sealing region in particular has substantially the same angle as the sealing section.

This configuration has the advantage that the sealing surface is increased in size for a more reliable seal and a smaller consumption of actuation medium. In addition, the inclined sealing surface can advantageously serve as an abutment.

The angle w is determined with respect to the direction of movement of the piston at intended use, with an angle w=0° corresponding to a parallel configuration of the sealing section and the direction of movement; an angle w=90° corresponds to a perpendicular configuration of the sealing section and the direction of movement. The angle w is determined as absolute; in other words, an alignment of the sealing section with respect to the direction of movement of 45° in the clockwise direction and of −45° in the counter-clockwise direction is understood as an angle w=45°.

At least the regions of the piston and of the housing in operative connection in the closed position for forming the seal are coated and/or surface treated. The coating and/or the surface treated sealing surface in particular has/have a modulus of elasticity E smaller than that of the piston and/or of the housing in the region of the coating. The coating and/or the surface treated region in particular has/have a modulus of elasticity E greater than 10 kN/mm², preferably greater than 50 kN/mm², and particularly preferably greater than 100 kN/mm².

This configuration has the advantage that the sealing is more reliable due to the use of coatings and/or due to a surface treatment of the sealing surface for forming the seal with the in particular smaller modulus of elasticity.

In a configuration in which the sealing region of the piston and of the sealing surface of the housing have different modulus of elasticity, the harder section, i.e. the sealing region or the sealing surface having the greater modulus of elasticity, in particular has a larger area than the softer section, i.e. the sealing region or the sealing surface with the smaller modulus of elasticity. The sealing region and the sealing surface are arranged with respect to one another in the closed position such that the formation of edges and/or grooves in the softer section is substantially avoided.

It is conceivable that the housing and the piston include the same coatings or different coatings in accordance with the respective demands. Metals such as copper or steel can be used as coatings, for example; alternatively the use of graphite is also conceivable.

The piston and the housing preferably comprise metal and/or ceramic material at least in the region of the seal. In a further preferred embodiment, the actuation apparatus substantially comprises metal, ceramic materials and graphite or any desired combinations thereof.

The use of metal, ceramic material and graphite for the manufacture of the actuation apparatus has the advantage that these materials are resistant with respect to high temperatures and radioactive radiation so that an actuation apparatus produced therefrom has a high service life.

The actuation apparatus preferably does not comprise an elastomer. This has the advantage that elastomers, which are frequently used as sealing material, often react negatively to high temperatures and/or radioactive radiation so that the elastomers lose the corresponding sealing properties, which can greatly reduce the service life of the actuation apparatus or possibly corresponding service intervals.

The piston preferably has a recess on the side facing the plunger into which the plunger at least partly projects at least in the closed position. In a further preferred embodiment, the resetting device is arranged at least partly in the recess.

This configuration has the advantage that a compact construction can be achieved, in particular at least with respect to the dimension of the actuation apparatus substantially along the direction of movement of the piston and/or of the plunger.

A sealing device is preferably arranged upstream of the seal on the outer side of the piston and/or on the inner wall of the piston space. The sealing device is in particular configured as a piston ring and/or as a labyrinth seal. The piston ring is preferably configured as a metal piston ring.

The arrangement of the sealing device downstream of the seal has the advantage that the formation of a pressure difference between the inlet and the seal is assisted, which simplifies a movement of the piston from the open position into the closed position and possibly reduces the consumption of actuation medium by a faster reaching of the closed position.

A further aspect of the present invention relates to a power plant comprising a valve and an actuation apparatus for the valve. The actuation apparatus is configured as an actuation apparatus as described above. The power plant is in particular a nuclear power plant having a reactor building.

Power plants, and in particular nuclear power plants, typically have an emergency cooling system or also a security system for preventing excess pressure in an energy generation system. Valves can be arranged in the emergency cooling system, in the safety system or also in the energy generation system and can be actuated by means of the actuation apparatus in accordance with the demands of the respective system.

A further aspect of the present invention relates to a method of actuating a valve by means of an actuation apparatus. The actuation apparatus is in particular configured as described above. The method comprises the steps of supplying a pneumatic or hydraulic actuation medium into a piston space through an inlet of a housing of the actuation apparatus. A movement of a piston arranged in the piston space from an open position into a closed position subsequently takes place by the actuation medium for actuating the valve. In addition, a sealing of the piston space for the actuation medium takes place in the closed position by means of a seal formed by an operative connection of the piston and of the housing. The seal is in particular formed downstream of the inlet. The seal is formed such that the actuation medium can substantially not flow downstream of the seal. The seal has a modulus of elasticity E greater than 10 kN/mm².

### BRIEF DESCRIPTION OF THE DRAWINGS

The invention will be explained in more detail hereinafter with reference to the drawings.

FIG. 1 is a sectional representation of an actuation apparatus in accordance with the invention;

FIG. 2 is a sectional representation of an alternative actuation apparatus in accordance with the invention;

FIG. 3 is a schematic representation of an actuation apparatus in accordance with the invention with a valve; and

FIG. 4 is a schematic representation of a nuclear power plant with the actuation apparatus in accordance with the invention in accordance with FIG. 1.

### DETAILED DESCRIPTION OF THE EMBODIMENTS

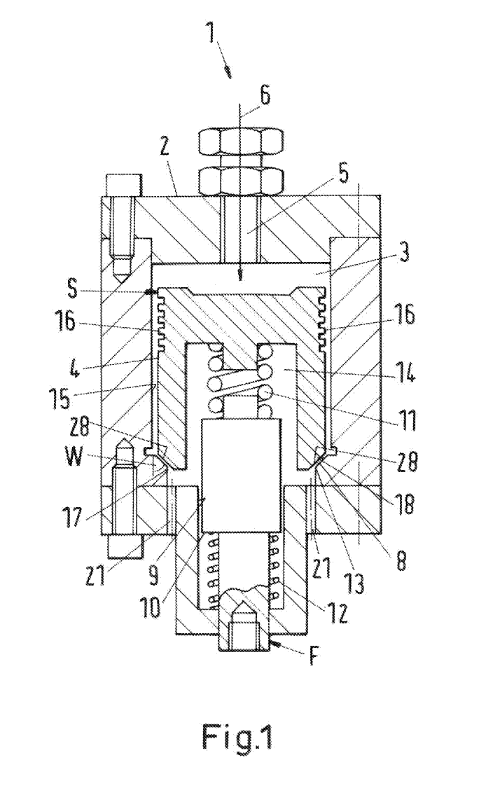

An actuation apparatus 1 in accordance with the invention is shown schematically in a sectional representation in FIG. 1.

The actuation apparatus 1 comprises a housing 2 having a piston space 3. A piston 4 is arranged in the piston space 3. The piston 4 is arranged movably, with a movement substantially taking place parallel to the longitudinal axis of the actuation apparatus 1; the longitudinal axis is arranged substantially in parallel with the arrow which is marked by 6 and which symbolizes the supply of the pneumatic actuation medium such as of steam, for example.

The housing 2 has an inlet 5 for the pneumatic actuation medium 6; alternatively, it is naturally also conceivable to use a hydraulic actuation medium 6 such as water, for example, instead of a pneumatic actuation medium.

The piston 4 has a sealing device 16 configured as a labyrinth seal, with the sealing effect being achieved in interaction with an inner wall 15 of the housing 2. The sealing device 16 is arranged upstream of a seal comprising a sealing surface 8. It is naturally also conceivable to configure the piston 4 without the sealing device 16.

On the side of the piston 4 remote from the inlet 5, the piston is chamfered at the outer side at an angle of 45° with respect to the direction of movement of the piston 4, whereby a sealing region 28 is formed. The housing 2 has a sealing surface 8 having a sealing section 17, with the sealing section 17 forming the total sealing surface 8 in the present case; alternatively, it is naturally conceivable that the sealing section 17 only forms a part of the sealing surface 8. The sealing section 17 has an angle w=45° with respect to the direction of movement of the piston 4 at intended use.

In the closed position S of the piston 4, the chamfered sealing region 28 of the piston 4 and the sealing section 17 are in operative connection such that a sealing is formed at the sealing surface 8. Optionally, a coating 18 can be arranged on the sealing surface 8 and the coating can, for example, be a copper coating; the coating can naturally alternatively or additionally be applied likewise to the sealing region 28 of the piston 4; alternatively, it is naturally also conceivable to subject the sealing surface 8 and/or the sealing region 28 to a surface treatment instead of the coating 18 or additionally to the coating 18 to adapt the modulus of elasticity such that an ideal sealing 8 is formed.

In the closed section S, the piston 4 contact an abutment 13 which is formed by the sealing surface 8. The position of the piston 4 is defined in the closed position S by means of the abutment 13.

The actuation apparatus 1 has a plunger guide 9 having a plunger 10 arranged therein. The piston 10 is likewise arranged movably, with a movement substantially taking place parallel to the longitudinal axis of the actuation apparatus 1. A resetting device configured as a resetting spring 12 is arranged in the plunger guide 9. The plunger guide 9 and a recess are in flow communication with the environment of the actuation apparatus by means of a fluid connection 21 which is configured as bores in the housing here.

The piston 4 has a recess 14 on the side facing the plunger 10 and the plunger 10 projects at least partly into it at least in the closed position S. In addition, a spring element configured as a compression spring 11 is arranged in the recess.

In operation, an actuation of a valve, not shown here, takes place by a supply of a pneumatic actuation medium 6 such as steam or air through the inlet 5 of the housing 2. The actuation medium 6 is conveyed into the piston space 3 and thus exerts a force onto the piston 4 which is in an open position, not shown here, at the start; in the open position, the piston 4 is offset upwardly against the arrow 6, with the plunger 10 being in a start position, not shown here, in which the plunger is upwardly offset against the arrow 6.

The piston 4 is moved in the direction of the sealing surface 8 or of the abutment 13 by the supply of the actuation medium 6. During the movement into the closed position S, the actuation medium 6 can move toward the plunger guide 9 and toward the recess 14 and can escape into the environment through the fluid connection 21. This loss of actuation medium 6 can be reduced by the sealing device 16.

A compression of the compression spring 11 and thus a movement of the plunger 10 into an end position F takes place by the movement of the piston 4 into the closed position S. When the piston 4 has reached the closed position S, a sealing of the piston space 3 from the plunger guide 9 and from the recess 14 takes place such that substantially no further loss of actuation medium 6 takes place. The maximum preload of the compressed air 11 and of the resetting spring 12 is present in the closed position S of the piston 4, wherein the closed position S is reliably defined by means of the abutment 13.

After the end of the supply of the actuation medium 6, a resetting of the piston 4 into the open position and a resetting of the plunger 10 into the start position by means of the resetting spring 12 take place.

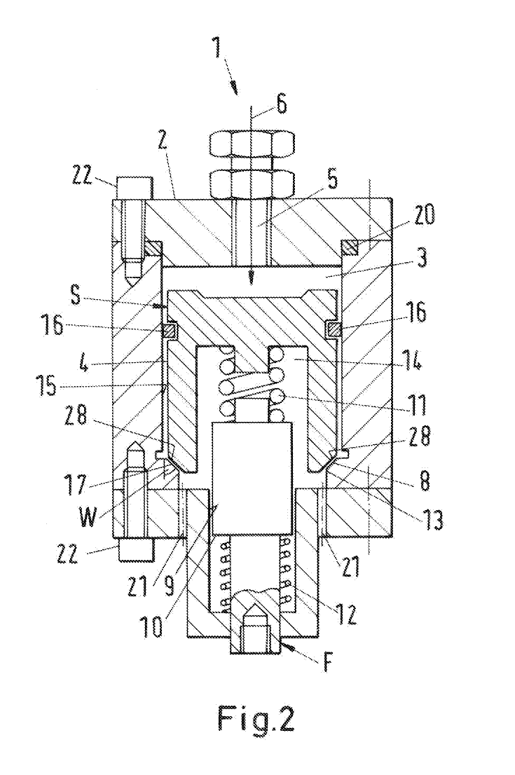

An alternative actuation apparatus 1 in accordance with the invention is shown schematically in a sectional representation in FIG. 2.

The same reference numerals designate the same features in all Figures and are therefore only explained again as required.

Unlike the actuation apparatus in accordance with FIG. 1, the actuation apparatus 1 in accordance with FIG. 2 has a sealing device 16 configured as a piston ring. The piston ring is configured as a steel ring, in particular having a nitrated or hard-chromium plated surface.

In addition, the actuation apparatus 1 has a housing seal 20 of graphite for ensuring the seal tightness of the housing 2. The housing 2 is configured in multiparts, with the parts of the housing being releasably connected to one another. For this purpose, the housing 2 has a screw connection device 22 which is only shown on the left hand side of the actuation apparatus 1 for better clarity. It is naturally also conceivable to configure the housing 2 in one part.

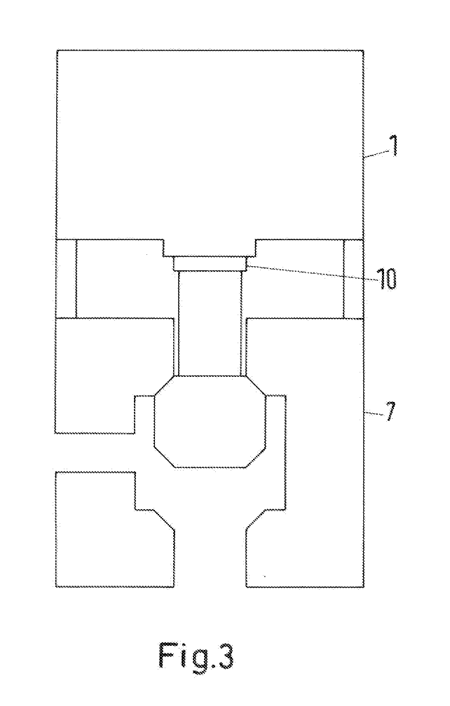

An actuation apparatus 1 in accordance with the invention is shown schematically in FIG. 3. A valve 7 can be actuated by means of the plunger 10. An actuation apparatus in accordance with FIG. 1 or also in accordance with FIG. 2 can be used as the actuation apparatus, for example.

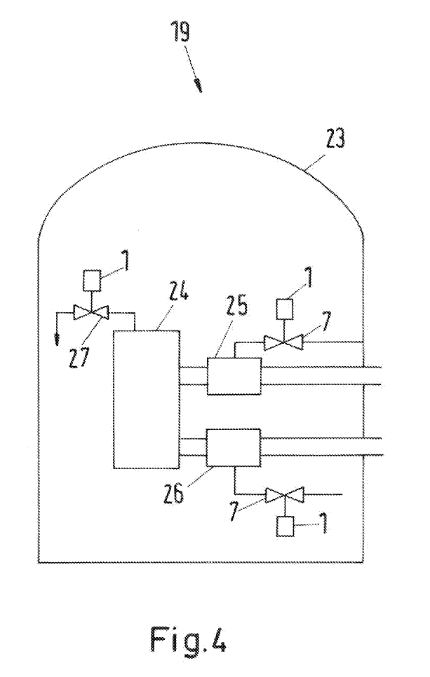

A nuclear power plant 19 with the actuation apparatus 1 in accordance with the invention in accordance with FIG. 1 is shown schematically in FIG. 4.

The nuclear power plant 19 comprises a reactor building 23 in which a reactor 24 is arranged. The reactor building 23 has a protective shell.

The reactor 24 is connected to lines for supplying and leading away liquids and/or gases. A steam insulation valve 25, a feed water insulation valve 26 and an excess pressure valve 27 are arranged in the lines and can be actuated directly or indirectly by means of actuation apparatus 1 for a safe operation.

1. An actuation apparatus comprising:
a housing having an inlet for a pneumatic or hydraulic actuation medium to pass into at least one piston space of the housing; and
a piston movably arranged in the piston space and being movable by the actuation medium at least between an open position and a closed position such that a valve is capable of being actuated at least by movement from the open position into the closed position, the piston and the housing being in operative connection with one another in the closed position such that a seal, including a sealing surface of the housing, is formed downstream of the inlet for sealing the piston space for the actuation medium toward an environment of the actuation apparatus, at least regions of the piston and of the housing in operative connection have a modulus of elasticity greater than 10 kN/mm2.

2. An actuation apparatus in accordance with claim 1, wherein the housing has at least one plunger guide having a plunger movably arranged therein, the plunger being movable at least from a start position into an end position by the piston for actuating the valve.

3. An actuation apparatus in accordance with claim 2, further comprising a spring element arranged between the piston and the plunger with respect to an effective direction of the force of the piston onto the plunger for damping or for decoupling the force exerted by the actuation medium onto the piston from the plunger.

4. An actuation apparatus in accordance with claim 2, wherein the plunger guide or a recess arranged in the piston on a side remote from the piston space is substantially sealed by the seal toward the piston space in the closed position of the piston, and the plunger guide or the recess is in flow communication with the environment of the actuation apparatus.

5. An actuation apparatus in accordance with claim 3, further comprising a resetting device in operative connection with the piston or with the plunger is arranged at or in the housing for resetting the piston into the open position or the plunger into the start position.

6. An actuation apparatus in accordance with claim 1, further comprising an abutment for the piston arranged at or in the housing, with at least one region of the piston being in operative connection with the abutment in the closed position.

7. An actuation apparatus in accordance with claim 1, wherein at least one sealing section of the sealing surface is inclined at an angle greater than 0° and smaller than 90° with respect to the direction of movement of the piston while in use, with the piston being chamfered in the sealing region of the operative connection such that the operative connection of the piston with the housing can be achieved for forming the seal.

8. An actuation apparatus in accordance with claim 1, wherein at least the regions of the piston and of the housing in operative connection in the closed position is coated with a coating or surface treated for forming the seal, the coating or a surface treated having a modulus of elasticity smaller than that of the piston or of the housing in the region of the coating or in the surface treated region.

9. An actuation apparatus in accordance with claim 1, wherein the piston and the housing include metal or ceramic material at least in the region of the seal.

10. An actuation apparatus in accordance with claim 1, wherein the actuation apparatus substantially comprises at least one of metal, ceramic material and graphite.

11. An actuation apparatus in accordance with claim 1, wherein the actuation apparatus does not comprise an elastomer.

12. An actuation apparatus in accordance with claim 5, the recess of the piston is on a side facing the plunger and the plunger projects at least partly into the recess in the closed position.

13. An actuation apparatus in accordance with claim 12, wherein the resetting device is arranged at least partly in the recess.

14. An actuation apparatus in accordance with claim 1, further comprising a sealing device arranged upstream of the seal on an outer side of the piston or an inner wall of the piston space.

15. A power plant comprising
a reactor building including a valve and an actuation apparatus in accordance with claim 1 for the valve.

16. A method of actuating a valve by an actuation apparatus, in particular in accordance with claim 1, comprising:
supplying a pneumatic or hydraulic actuation medium into a piston space through an inlet of a housing of the actuation apparatus;
moving a piston arranged in the piston space by the actuation medium from an open position into a closed position for actuating the valve; and
sealing the piston space for the actuation medium in the closed position by a seal formed by an operative connection of the piston and of the housing such that the actuation medium can substantially not flow downstream of the seal, the seal having a modulus of elasticity greater than 10 kN/mm2.

17. An actuation apparatus in accordance with claim 1, wherein the modulus of elasticity of the regions of the piston and of the housing in operative connection are greater than greater than 100 kN/mm2.

18. An actuation apparatus in accordance with claim 3, wherein the spring element is a compression spring.

19. An actuation apparatus in accordance with claim 5, wherein the resetting device is a resetting spring.

20. An actuation apparatus in accordance with claim 14, wherein the sealing device is a metal piston ring or a labyrinth.
